(19) United States
(12) Patent Application Publication
(10) Pub. No.: US 2026/0357160 A1
(43) Pub. Date: Nov. 12, 2026

(54) Home Care Compositions

(71) Applicant: Colgate-Palmolive Company, New York, NY (US)

(72) Inventors: Maria Antonieta VALDES VERGARA, Mexico City (MX); Henry PENA, Huixquilucan (MX); Luis Javier RIVERA CRUZ, Cuautitlan Izcalli (MX); Jorge Antonio MALDONADO ORTEGA, Mexico City (MX)

(73) Assignee: Colgate-Palmolive Company, New York, NY (US)

(21) Appl. No.: 19/127,872

(22) PCT Filed: Dec. 14, 2023
(86) PCT No.: PCT/US2023/083963

§ 371 Date: May 7, 2025

Related U.S. Application Data
(60) Provisional application No. 63/432,499, filed on Dec. 14, 2022.

(51) Int. Cl. C11D 3/48; C11D 1/14; C11D 1/72; C11D 1/835; C11D 3/04; C11D 3/10; C11D 3/20; C11D 3/32; C11D 3/37; C11D 3/39

(52) U.S. Cl. CPC C11D 3/48; C11D 1/835; C11D 3/046; C11D 3/10; C11D 3/2086; C11D 3/32; C11D 3/3707; C11D 3/3942; C11D 1/146; C11D 1/72

(57) ABSTRACT

Described herein are cleaning compositions comprising an alkali metal bicarbonate, an alkali metal carbonate, an acid source, an antibacterial composition comprising sodium percarbonate and tetraacetylethylenediamine, and wherein the sodium percarbonate is present in an amount ranging from about 2 wt. % to about 15 wt. % based on the total weight of the cleaning composition, and the tetraacetylethylenediamine in an amount ranging from about 1 wt. % to about 7 wt. % based on the total weight of the cleaning composition.

### CROSS-REFERENCE TO RELATED APPLICATIONS

This application claims the benefit of priority from U.S. Provisional Application No. 63/432,499, filed Dec. 14, 2022, the contents of which are hereby incorporated herein by reference in their entirety.

### BACKGROUND

Solid cleaning composition existed previously in the form of granular or “dry” laundry detergent products. However, such compositions are specifically formulated for cleaning performance in laundry detergent applications and offer poor performance in terms of imparting a reduction in bacteria on various surfaces. Therefore, a need exists for a solid cleaning composition that can impart antibacterial cleaning characteristics.

### BRIEF SUMMARY

The present invention is directed to a cleaning composition comprising: an alkali metal bicarbonate; an alkali metal carbonate; an acid source; an antibacterial composition comprising sodium percarbonate and tetraacetylethylenediamine; and wherein the sodium percarbonate is present in an amount ranging from about 2 wt. % to about 15 wt. % based on the total weight of the cleaning composition, and the tetraacetylethylenediamine in an amount ranging from about 1 wt. % to about 7 wt. % based on the total weight of the cleaning composition.

Other embodiments of the present invention include a cleaning composition comprising: an alkali metal bicarbonate; an alkali metal carbonate; an acid source; an antibacterial composition comprising sodium percarbonate and tetraacetylethylenediamine; and wherein the sodium percarbonate and the tetraacetylethylenediamine are present in a weight ratio ranging from about 1:1 to about 3:1 and the antibacterial composition is present in an amount ranging from about 3 wt. % to about 22 wt. % based on the total weight of the cleaning composition.

Other embodiments of the present invention include a cleaning composition comprising sodium bicarbonate; sodium carbonate; citric acid; surfactant composition; sodium percarbonate; tetraacetylethylenediamine; and wherein the sodium percarbonate is present in an amount ranging from about 2 wt. % to about 15 wt. % based on the total weight of the cleaning composition, and the tetraacetylethylenediamine in an amount ranging from about 1 wt. % to about 7 wt. % based on the total weight of the cleaning composition so long as the sodium percarbonate and the tetraacetylethylenediamine are present in a weight ratio ranging from about 1:1 to about 3:1.

Other embodiments of the present invention include a method of cleaning a surface, the comprising: a) blending together a volume of water with one of the aforementioned cleaning compositions to create a dissolved liquid cleaning composition; and b) applying the dissolved liquid cleaning composition to the surface.

Other embodiments of the present invention include a method of manufacture of a cleaning composition the comprising: a) blending together an alkali metal bicarbonate; an alkali metal carbonate; an acid source; a solidifying agent; an antibacterial composition to form a precursor blend; b) machining (e.g., extruding using a soap extruder) the precursor blend into a solid shape; c) filling a container with a volume of the solid shape; and wherein the solid shape is substantially free of liquid carrier, and wherein the antibacterial composition comprises sodium percarbonate and tetraacetylethylenediamine, the sodium percarbonate being present in an amount ranging from about 2 wt. % to about 15 wt. % based on the total weight of the cleaning composition, and the tetraacetylethylenediamine in an amount ranging from about 1 wt. % to about 7 wt. % based on the total weight of the precursory blend.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### DETAILED DESCRIPTION

The following description of the preferred embodiment(s) is merely exemplary in nature and is in no way intended to limit the invention, its application, or uses.

As used throughout, ranges are used as shorthand for describing each and every value that is within the range. Any value within the range can be selected as the terminus of the range. In addition, all references cited herein are hereby incorporated by referenced in their entireties. In the event of a conflict in a definition in the present disclosure and that of a cited reference, the present disclosure controls.

Unless otherwise specified, all percentages and amounts expressed herein and elsewhere in the specification should be understood to refer to percentages by weight. The amounts given arc based on the active weight of the material.

The description of illustrative embodiments according to principles of the present invention is intended to be read in connection with the accompanying drawings, which are to be considered part of the entire written description. In the description of embodiments of the invention disclosed herein, any reference to direction or orientation is merely intended for convenience of description and is not intended in any way to limit the scope of the present invention. Relative terms such as “lower,” “upper,” “horizontal,” “vertical,” “above,” “below,” “up,” “down,” “top,” and “bottom” as well as derivatives thereof (e.g., “horizontally,” “downwardly,” “upwardly,” etc.) should be construed to refer to the orientation as then described or as shown in the drawing under discussion. These relative terms are for convenience of description only and do not require that the apparatus be constructed or operated in a particular orientation unless explicitly indicated as such.

Unless otherwise specified, all percentages and amounts expressed herein and elsewhere in the specification should be understood to refer to percentages by weight. The amounts given are based on the active weight of the material. According to the present application, the term “about” means+/−5% of the reference value. According to the present application, the term “substantially free” less than about 0.1 wt. % based on the total of the referenced value.

The present invention is directed to a cleaning composition that imparts antibacterial benefits to surfaces that the cleaning composition contacts. The cleaning composition of the present invention may be suitable for a reduction in bacteria including, but not limited to, E. coli, S. typhimurium, S. aureus, P. aeruginosa—as discussed in greater detail herein.

The cleaning composition of the present invention may have an alkaline pH—the term “alkaline pH” refers to a pH that is higher than neutral (i.e., a pH of 7). In some embodiments, the cleaning composition of the present invention may have a pH ranging from about 8.0 to about 11.0—including all pH values and sub-ranges there-between. For instance, the cleaning composition may have a pH of about 8 to about 11, about 8.5 to about 11, about 9 to about 11, about 9.5 to about 11, about 10 to about 11; from about 8 to about 10.5, about 8.5 to about 10.5, about 9 to about, about 9.5 to about 10.5; about 8 to about 10, about 8.5 to about 10, about 9 to about 10; about 8 to about 9.5, about 8.5 to about 9.5, or about 8 to about 9—including all pH values and sub-ranges there-between. In some embodiments, the cleaning composition of the present invention may have a pH ranging from about 8.0 to about 9.0—including all pH values and sub-ranges there-between. In some embodiments, the cleaning composition of the present invention may have a pH ranging from about 8.0 to about 8.5—including all pH values and sub-ranges there-between.

The cleaning composition may comprise an antibacterial composition comprising a first component and a second component. The first component may be selected from perborates and percarbonates. The percarbonates may be selected from alkali metal percarbonates, such as sodium percarbonate and potassium percarbonate. In some embodiments, the first component consists of one or more perborates, one or more percarbonates, or a combination of two or more thereof. In at least one embodiment, the first component consists of one or more perborate. The percarbonate may be in coated form or a non-coated form. Percarbonate salts can be prepared by a fluid bed process or by a crystallization process. Suitable perborate salts include sodium perborate mono-hydrate (PB1), sodium perborate tetra-hydrate (PB4), and anhydrous sodium perborate which is also known as fizzing sodium perborate. Other suitable sources of AvOx include persulphate, such as oxone. Another suitable source of AvOx is hydrogen peroxide.

The first component may comprise sodium percarbonate. The second component may comprise tetraacetylethylenediamine (“TAED”). The second component may include compounds which, under perhydrolysis conditions, give aliphatic peroxoycarboxylic acids having preferably from 1 to 12 carbon atoms (e.g., from 2 to 10 carbon atoms), and/or optionally substituted perbenzoic acid. For example, the second component may be selected from polyacylated alkylenediamines, in particular tetraacetylethylenediamine (TAED); acylated triazine derivatives, such as 1,5-diacetyl-2,4-dioxohexahydro-1,3,5-triazine (DADHT); acylated glycolurils, such as tetraacetylglycoluril (TAGU); N-acylimides, such as N-nonanoylsuccinimide (NOSI); acylated phenolsulfonates, such as n-nonanoyl- or isononanoyloxybenzenesulfonate (n- or iso-NOBS), decanoyloxybenzoic acid (DOBA); carboxylic anhydrides, such as phthalic anhydride; acylated polyhydric alcohols, such as triacetin, ethylene glycol diacetate, 2,5-diacetoxy-2,5-dihydrofuran and triethylacetyl citrate (TEAC). In some embodiments, the second component comprises tetraacetylethylenediamine, decanoyloxybenzoic acid, 1,5-diacetyl-2,4-dioxohexahydro-1,3,5-triazine, tetraacetylglycoluril, decanoyloxybenzoic acid, or a combination of two or more thereof. In certain embodiments, the second component consists of one or more polyacylated alkylenediamines, one or more acylated triazine derivatives, one or more acylated glycolurils, one or more N-acylimides, one or more acylated phenolsulfonates, one or more carboxylic anhydrides, one or more acylated polyhydric alcohols, or a combination of two or more thereof.

The antibacterial composition may be present in an amount ranging from about 3 wt. % to about 22 wt. %, based on the total weight of the cleaning composition—including all percentages and sub-ranges there-between. For example, the total amount of the antibacterial composition present in the cleaning composition may be from about 3 wt. % to about 22 wt. %, about 3 wt. % to about 20 wt. %, about 3 wt. % to about 18 wt. %, about 3 wt. % to about 16 wt. %, about 3 wt. % to about 13 wt. %, about 3 wt. % to about 10 wt. %, about 3 wt. % to about 7 wt. %; from about 4.5 wt. % to about 22 wt. %, about 4.5 wt. % to about 20 wt. %, about 4.5 wt. % to about 18 wt. %, about 4.5 wt. % to about 16 wt. %, about 4.5 wt. % to about 13 wt. %, about 4.5 wt. % to about 10 wt. %, about 4.5 wt. % to about 7 wt. %; from about 6 wt. % to about 22 wt. %, about 6 wt. % to about 20 wt. %, about 6 wt. % to about 18 wt. %, about 6 wt. % to about 16 wt. %, about 6 wt. % to about 13 wt. %, about 6 wt. % to about 10 wt. %; from about 8 wt. % to about 22 wt. %, about 8 wt. % to about 20 wt. %, about 8 wt. % to about 18 wt. %, about 8 wt. % to about 16 wt. %, about 8 wt. % to about 13 wt. %; from about 11 wt. % to about 22 wt. %, about 11 wt. % to about 20 wt. %, about 11 wt. % to about 18 wt. %, about 11 wt. % to about 16 wt. %; from about 14 wt. % to about 22 wt. %, about 14 wt. % to about 20 wt. %, about 14 wt. % to about 18 wt. %, about 14 wt. % to about 16 wt. %; from about 17 wt. % to about 22 wt. %, about 17 wt. % to about 20 wt. %, based on the total weight of the cleaning composition—including all percentages and sub-ranges there-between. In some embodiments, the antibacterial composition may be present in an amount ranging from about 4.5 wt. % to about 18 wt. %, based on the total weight of the cleaning composition—including all percentages and sub-ranges there-between.

The first component and the second component may be present in a weight ratio ranging from about 3.0:1 to about 1.0:1—including all ratios and sub-ranges there-between. In some embodiments, the first component and the second component may be present in a weight ratio ranging from about 2.9:1 to about 1.1:1—including all ratios and sub-ranges there-between. In some embodiments, the first component and the second component may be present in a weight ratio ranging from about 2.8:1 to about 1.2:1—including all ratios and sub-ranges there-between. In some embodiments, the first component and the second component may be present in a weight ratio ranging from about 2.7:1 to about 1.3:1—including all ratios and sub-ranges there-between. In some embodiments, the first component and the second component may be present in a weight ratio ranging from about 2.6:1 to about 1.4:1—including all ratios and sub-ranges there-between. In some embodiments, the first component and the second component may be present in a weight ratio ranging from about 2.5:1 to about 1.5:1—including all ratios and sub-ranges there-between. In some embodiments, the first component and the second component may be present in a weight ratio ranging from about 2.4:1 to about 1.6:1—including all ratios and sub-ranges there-between. In some embodiments, the first component and the second component may be present in a weight ratio ranging from about 2.3:1 to about 1.7:1—including all ratios and sub-ranges there-between. In some embodiments, the first component and the second component may be present in a weight ratio ranging from about 2.2:1 to about 1.8:1—including all ratios and sub-ranges there-between. In some embodiments, the first component and the second component may be present in a weight ratio ranging from about 2.1:1 to about 1.9:1—including all ratios and sub-ranges there-between. In some embodiments, the first component and the second component may be present in a weight ratio of 2.0:1.

The first component may comprise sodium percarbonate in an amount ranging from about 2 wt. % to about 15 wt. %, based on the total weight of the cleaning composition—including all percentages and sub-ranges there-between. In some embodiments, the first component may comprise sodium percarbonate in an amount ranging from about 2 wt. % to about 4 wt. %, based on the total weight of the cleaning composition—including all percentages and sub-ranges there-between. In some embodiments, the first component may comprise sodium percarbonate in an amount ranging from about 11 wt. % to about 13 wt. %, based on the total weight of the cleaning composition—including all percentages and sub-ranges there-between. Additionally or alternatively, the total amount of first component (e.g., perbonates and percarbonates, such as sodium percarbonate) in cleaning composition may be from about 2 wt. % to about 15 wt. %, about 2 wt. % to about 12 wt. %, about 2 wt. % to about 9 wt. %, about 2 wt. % to about 7 wt. %, about 2 wt. % to about 5 wt. %; from about 4 wt. % to about 15 wt. %, about 4 wt. % to about 12 wt. %, about 4 wt. % to about 9 wt. %, about 4 wt. % to about 7 wt. %; from about 6 wt. % to about 15 wt. %, about 6 wt. % to about 12 wt. %, about 6 wt. % to about 9 wt. %; from about 8 wt. % to about 15 wt. %, about 8 wt. % to about 12 wt. %, about 8 wt. % to about 10 wt. %; from about 11 wt. % to about 15 wt. %, about 11 wt. % to about 13 wt. %, about 12 wt. % to about 15 wt. %, based on the total weight of the cleaning composition—including all percentages and sub-ranges there-between.

The second component may comprise tetraacetylethylenediamine in an amount ranging from about 1 wt. % to about 7 wt. %, based on the total weight of the cleaning composition-including all percentages and sub-ranges there-between. For instance, the amount of tetraacetylethylenediamine present in the cleaning composition may be from about 1 wt. % to about 7 wt. %, about 1 wt. % to about 5 wt. %, about 1 wt. % to about 4 wt. %, about 1 wt. % to about 3 wt. %, about 1 wt. % to about 2 wt. %; from about 2 wt. % to about 7 wt. %, about 2 wt. % to about 5 wt. %, about 2 wt. % to about 4 wt. %, about 2 wt. % to about 3 wt. %; from about 3 wt. % to about 7 wt. %, about 3 wt. % to about 5 wt. %, about 3 wt. % to about 4 wt. %; from about 4 wt. % to about 7 wt. %, about 4 wt. % to about 5 wt. %; from about 5 wt. % to about 7 wt. %, about 5 wt. % to about 6 wt. %, based on the total weight of the cleaning composition-including all percentages and sub-ranges there-between. In some embodiments, the second component may comprise tetraacetylethylenediamine in an amount ranging from about 1 wt. % to about 2 wt. %, based on the total weight of the cleaning composition—including all percentages and sub-ranges there-between. In some embodiments, the second component may comprise tetraacetylethylenediamine in an amount ranging from about 5 wt. % to about 7 wt. %, based on the total weight of the cleaning composition—including all percentages and sub-ranges there-between. Additionally or alternatively, the total amount of the second component may be present in the cleaning composition in an amount from about 1 wt. % to about 7 wt. %, about 1 wt. % to about 5 wt. %, about 1 wt. % to about 4 wt. %, about 1 wt. % to about 3 wt. %, about 1 wt. % to about 2 wt. %; from about 2 wt. % to about 7 wt. %, about 2 wt. % to about 5 wt. %, about 2 wt. % to about 4 wt. %, about 2 wt. % to about 3 wt. %; from about 3 wt. % to about 7 wt. %, about 3 wt. % to about 5 wt. %, about 3 wt. % to about 4 wt. %; from about 4 wt. % to about 7 wt. %, about 4 wt. % to about 5 wt. %; from about 5 wt. % to about 7 wt. %, about 5 wt. % to about 6 wt. %, based on the total weight of the cleaning composition—including all percentages and sub-ranges there-between.

In a non-limiting embodiment, the antibacterial composition may comprise sodium percarbonate in an amount ranging from about 2 wt. % to about 4 wt. % and the tetraacetylethylenediamine in an amount ranging from about 1 wt. % to about 2 wt. %-both amounts based on the total weight of the cleaning composition. In some embodiments, the antibacterial composition may comprise sodium percarbonate in an amount of about 3 wt. % and the tetraacetylethylenediamine in an amount of about 1.5 wt. %-both amounts based on the total weight of the cleaning composition.

In a non-limiting embodiment, the antibacterial composition may comprise sodium percarbonate in an amount ranging from about 11 wt. % to about 13 wt. % and the tetraacetylethylenediamine in an amount ranging from about 5 wt. % to about 7 wt. %-both amounts based on the total weight of the cleaning composition. In some embodiments, the antibacterial composition may comprise sodium percarbonate in an amount of about 12 wt. % and the tetraacetylethylenediamine in an amount of about 6 wt. %-both amounts based on the total weight of the cleaning composition.

It has been surprisingly discovered that the antibacterial composition comprising the combination of sodium percarbonate and tetraacetylethylenediamine provides an unexpected improvement in the reduction of bacteria in a solid cleaning composition. As discussed in greater detail herein-it has been discovered that the combination of sodium percarbonate and tetraacetylethylenediamine provides an unexpected reduction in at least the bacteria including E. coli, S. typhimurium, S. aureus, P. aeruginosa—for relatively fast contact times of the cleaning composition once in a dissolved state (i.e., less than about 10 minutes).

The cleaning composition may be effervescent. The cleaning component may comprise an effervescent component. The effervescent component may, on contact with water, cause the cleaning composition to produce a bubble-forming effect. The effervescence may be as a result of gas trapped in the matrix of the particle being released when the particle contacts water, or more usually, is the result of a reaction which takes place between two or more reactants present in the effervescence particle which, on contact with water react with one another to produce a gas.

The time an effervescent product takes to dissolve is affected by several factors. In addition to the environment in which it is used, key among these factors are: its form (tablet, granule or powder); its size and its density; its hardness and the formulation itself. Effervescent compositions—such as the cleaning composition of the present invention—may dissolve quickly, generally within a few seconds. Such effervescent compositions may react immediately, generally on the surface of the water

The effervescent component may be present in an amount ranging from about 22 wt. % to about 40 wt. %-based on the total weight of the cleaning composition, including all percentages and sub-ranges there-between. In some embodiments, the effervescent component may be present in an amount ranging from about 25 wt. % to about 37 wt. %—based on the total weight of the cleaning composition, including all percentages and sub-ranges there-between.

The effervescent component may comprise a blend of an acid source and a carbonate salt. The carbonate salt and the acid source may be present in a weight ratio ranging from about 1.5:1 to about 5.5:1—including all ratios and sub-ranges there-between. In some embodiments, the carbonate salt and the acid source may be present in a weight ratio ranging from about 1.5:1 to about 4.8:1—including all ratios and sub-ranges there-between.

The acid source and the carbonate salt may be physically “glued” together using a solidifying agent (also referred to as a binder)—as discussed in greater detail herein.

Non-limiting examples of the carbonate salt include sodium bicarbonate, sodium carbonate, Potassium carbonate, potassium bicarbonate, magnesium carbonate, and calcium carbonate. In some embodiments, the carbonate salt of the effervescent component is an alkali metal bicarbonate. In some embodiments, the alkali metal bicarbonate is sodium bicarbonate.

Non-limiting examples of acid sources include solid organic, mineral or inorganic acids, salts or derivatives thereof or mixtures thereof. In some embodiments, the acid source may be mono-, bi- or tri-protonic acids. Such acids may include mono- or polycarboxyhc acids-such as citric acid, adipic acid, glutatric acid, tartaric acid, maleic acid, fumaric acid, malic acid, succinic acid, salicylic acid and malonic acid. Such acids may be in their acidic form. Alternatively, the acid source may be include esters of the acids. In some embodiments, the acid source is one or more of citric acid and malic acid. In some embodiments, the acid source is citric acid. The acid source, such as any the foregoing acids, may be incorporated as a salt thereof.

The acid source of the effervescent component may be present in an amount ranging from about 5 wt. % to about 15 wt. %, based on the total weight of the cleaning composition-including all percentages and sub-ranges there-between. For example, the acid source may be present in the cleaning composition in an amount from about 5 wt. % to about 15 wt. %, about 5 wt. % to about 12 wt. %, about 5 wt. % to about 9 wt. %, about 5 wt. % to about 7 wt. %; from about 7 wt. % to about 15 wt. %, about 7 wt. % to about 12 wt. %, about 7 wt. % to about 9 wt. %; from about 9 wt. % to about 15 wt. %, about 9 wt. % to about 12 wt. %; from about 11 wt. % to about 15 wt. %, about 11 wt. % to about 13 wt. %, about 12 wt. % to about 15 wt. %, based on the total weight of the cleaning composition—including all percentages and sub-ranges there-between. In some embodiments, the acid source of the effervescent component may be present in an amount ranging from about 6 wt. % to about 12 wt. %, based on the total weight of the cleaning composition-including all percentages and sub-ranges there-between.

The carbonate salt and/or bicarbonate salt of the effervescent component may be present in an amount ranging from about 15 wt. % to about 35 wt. %, based on the total weight of the cleaning composition—including all percentages and sub-ranges there-between. For instance, the carbonate salt and/or the bicarbaonte salt may be present in an amount from about 15 wt. % to about 35 wt. %, about 20 wt. % to about 35 wt. %, about 25 wt. % to about 35 wt. %, about 30 wt. % to about 35 wt. %; from about 15 wt. % to about 30 wt. %, about 20 wt. % to about 30 wt. %, about 25 wt. % to about 30 wt. %; from about 15 wt. % to about 25 wt. %, about 20 wt. % to about 25 wt. %; from about 15 wt. % to about 23 wt. %, about 15 wt. % to about 20 wt. %, based on the total weight of the cleaning composition—including all percentages and sub-ranges there-between. In some embodiments, the carbonate salt of the effervescent component may be present in an amount ranging from about 20 wt. % to about 31 wt. % based on the total weight of the cleaning composition—including all percentages and sub-ranges there-between. In some embodiments, the carbonate salt of the effervescent component may be present in an amount ranging from about 25 wt. % to about 31 wt. % based on the total weight of the cleaning composition—including all percentages and sub-ranges there-between.

The cleaning composition may comprise a separate and/or additional alkaline source. The separate and/or additional alkaline source may be incorporated into the cleaning composition in order to enhance cleaning of a substrate and/or improve impurity removal performance of the cleaning composition. If needed, the separate alkaline source may be incorporated into the cleaning composition to impart an alkaline pH—as discussed.

The separate and/or additional alkaline source may comprise one or more of an alkali metal carbonate and/or an alkali metal hydroxide. Non-limiting examples of alkali metal carbonates include sodium or potassium carbonate, bicarbonate, sesquicarbonate, mixtures thereof. Non-limiting examples of alkali metal hydroxides may include sodium or potassium hydroxide.

In some embodiments, the separate and/or additional alkaline source comprises sodium carbonate. In some embodiments, the separate and/or additional alkaline source comprises sodium carbonate as light soda ash. The term “light soda ash” refers to a low density sodium carbonate having a density of about 0.7 g/cm³.

The separate and/or additional alkaline source may be present in an amount ranging from about 1 wt. % to about 20 wt. %, based on the total weight of the cleaning composition-including all percentages and sub-ranges there-between. For instance, the additional alkaline source may be present in an amount from about 1 wt. % to about 17 wt. %, about 1 wt. % to about 14 wt. %, about 1 wt. % to about 11 wt. %, about 1 wt. % to about 8 wt. %; from from about 3 wt. % to about 20 wt. %, about 3 wt. % to about 17 wt. %, about 3 wt. % to about 14 wt. %, about 3 wt. % to about 11 wt. %, about 3 wt. % to about 8 wt. %; from about 5 wt. % to about 20 wt. %, about 5 wt. % to about 17 wt. %, about 5 wt. % to about 14 wt. %, about 5 wt. % to about 11 wt. %; from about 8 wt. % to about 20 wt. %, about 8 wt. % to about 17 wt. %, about 8 wt. % to about 14 wt. %, about 8 wt. % to about 11 wt. %; from about 11 wt. % to about 20 wt. %, about 11 wt. % to about 17 wt. %, about 11 wt. % to about 14 wt. %; from about 14 wt. % to about 20 wt. %, about 14 wt. % to about 17 wt. %, based on the total weight of the cleaning composition—including all percentages and sub-ranges there-between.

The separate and/or additional alkaline source may be present in an amount ranging from about 1 wt. % to about 10 wt. %, based on the total weight of the cleaning composition-including all percentages and sub-ranges there-between.

The cleaning composition may comprise a surfactant composition. The surfactant composition may be present in an amount ranging from about 1 wt. % to about 45 wt. % based on the total weight of the cleaning composition—including all percentages and sub-ranges there-between. For example, the cleaning composition may comprise one or more surfactant in an amount from about 1 wt. % to about 45 wt. %, about 1 wt. % to about 40 wt. %, about 1 wt. % to about 35 wt. %, about 1 wt. % to about 30 wt. %, about 1 wt. % to about 25 wt. %, about 1 wt. % to about 20 wt. %, about 1 wt. % to about 15 wt. %, about 1 wt. % to about 10 wt. %; from about 5 wt. % to about 45 wt. %, about 5 wt. % to about 40 wt. %, about 5 wt. % to about 35 wt. %, about 5 wt. % to about 30 wt. %, about 5 wt. % to about 25 wt. %, about 5 wt. % to about 20 wt. %, about 5 wt. % to about 15 wt. %, about 5 wt. % to about 10 wt. %; from about 10 wt. % to about 45 wt. %, about 10 wt. % to about 40 wt. %, about 10 wt. % to about 35 wt. %, about 10 wt. % to about 30 wt. %, about 10 wt. % to about 25 wt. %, about 10 wt. % to about 20 wt. %, about 10 wt. % to about 15 wt. %; from about 15 wt. % to about 45 wt. %, about 15 wt. % to about 40 wt. %, about 15 wt. % to about 35 wt. %, about 15 wt. % to about 30 wt. %, about 15 wt. % to about 25 wt. %; from about 20 wt. % to about 45 wt. %, about 20 wt. % to about 40 wt. %, about 20 wt. % to about 35 wt. %, about 20 wt. % to about 30 wt. %; from about 25 wt. % to about 45 wt. %, about 25 wt. % to about 40 wt. %, about 25 wt. % to about 35 wt. %; from about 30 wt. % to about 45 wt. %, about 30 wt. % to about 40 wt. %, about 30 wt. % to about 35 wt. %; from about 35 wt. % to about 45 wt. %, about 35 wt. % to about 40 wt. %, based on the total weight of the cleaning composition—including all percentages and sub-ranges there-between. In some embodiments, the surfactant composition may be present in an amount ranging from about 10 wt. % to about 35 wt. %, based on the total weight of the cleaning composition—including all percentages and sub-ranges there-between. In some embodiments, the surfactant composition may be present in an amount ranging from about 15 wt. % to about 30 wt. %, based on the total weight of the cleaning composition—including all percentages and sub-ranges there-between.

The surfactant composition may comprise one or more surfactants. The surfactant composition may comprise one or more of an anionic surfactant, a nonionic surfactant, a cationic surfactant, and a zwitterionic surfactant.

Non-limiting examples of anionic surfactants include carboxylates such as alkylcarboxylates (carboxylic acid salts) and polyalkoxycarboxylates, alcohol ethoxylate carboxylates, nonylphenol ethoxylate carboxylates, and the like; sulfonates such as alkylsulfonates, alkylbenzenesulfonates, alkylarylsulfonates, sulfonated fatty acid esters, and the like; sulfates such as sulfated alcohols, sulfated alcohol ethoxylates, sulfated alkylphenols, alkylsulfates, sulfosuccinates, alkylether sulfates, and the like; and phosphate esters such as alkylphosphate esters, and the like. Preferred anionics are sodium alkylarylsulfonate, alpha-olefinsulfonate, and fatty alcohol sulfates.

The anionic surfactant may be present in an amount ranging from about 10 wt. % to about 30 wt. % based on the total weight of the cleaning composition—including all percentages and sub-ranges there-between.

In some embodiments, the anionic surfactant may comprise sodium lauryl sulfate. The sodium lauryl sulfate may be present in an amount ranging from about 15 wt. % to about 28 wt. % based on the total weight of the cleaning composition—including all percentages and sub-ranges there-between.

Non-limiting examples of nonionic surfactants include those having a polyalkylene oxide polymer as a portion of the surfactant molecule. Such nonionic surfactants include, for example, chlorine-, benzyl-, methyl-, ethyl-, propyl-, butyl- and other alkyl-capped polyethylene glycol ethers of fatty alcohols; polyalkylene oxide free nonionics such as alkyl polyglycosides; sorbitan and sucrose esters and their ethoxylates; alkoxylated ethylene diamine; alcohol alkoxylates such as alcohol ethoxylate propoxylates, alcohol propoxylates, alcohol propoxylate ethoxylate propoxylates, alcohol ethoxylate butoxylates, and the like; nonylphenol ethoxylate, polyoxyethylene glycol ethers and the like; carboxylic acid esters such as glycerol esters, polyoxyethylene esters, ethoxylated and glycol esters of fatty acids, and the like; carboxylic amides such as diethanolamine condensates, monoalkanolamine condensates, polyoxyethylene fatty acid amides, and the like; and polyalkylene oxide block copolymers including an ethylene oxide/propylene oxide block copolymer.

The non-ionic surfactant may be present in an amount ranging from about 1 wt. % to about 8 wt. % based on the total weight of the cleaning composition—including all percentages and sub-ranges there-between.

In some embodiments, the non-ionic surfactant may comprise a blend of C9, C10, and C11 alcohols having an EO 7.5-8:1 ratio—also referred to as neodol. In some embodiments, the non-ionic surfactant may comprise a fatty alcohol ethoxylate.

Non-limiting examples of cationic surfactants may include amines such as primary, secondary and tertiary monoamines with C18 alkyl or alkenyl chains, ethoxylated alkylamines, alkoxylates of ethylenediamine, imidazoles such as a 1-(2-hydroxyethyl)-2-imidazoline, a 2-alkyl-1-(2-hydroxyethyl)-2-imidazoline, and the like; and quaternary ammonium salts, as for example, alkylquaternary ammonium chloride surfactants such as n-alkyl (C12 C18) dimethylbenzyl ammonium chloride, n-tetradecyldimethylbenzylammonium chloride monohydrate, a naphthalene-substituted quaternary ammonium chloride such as dimethyl-1-naphthylmethylammonium chloride, and the like; and other like cationic surfactants.

Non-limiting examples of zwitterionic surfactants may include betaines, imidazolines, and propionates.

In some embodiments the cleaning composition may be substantially free of cationic surfactants. In some embodiments the cleaning composition may be substantially free of zwitterionic surfactants.

The cleaning composition may comprise a solidifying agent (also referred to as a “solidification agent” or a “binder”). The solidifying agent may be present in an amount ranging from about 10 wt. % to about 50 wt. %, based on the total weight of the cleaning composition-including all percentages and sub-ranges there-between. For example, the total amount of solidifying agents present in the cleaning composition may be from about 10 wt. % to about 45 wt. %, about 10 wt. % to about 40 wt. %, about 10 wt. % to about 35 wt. %, about 10 wt. % to about 30 wt. %, about 10 wt. % to about 25 wt. %, about 10 wt. % to about 20 wt. %, about 10 wt. % to about 15 wt. %; from about 15 wt. % to about 50 wt. %, about 15 wt. % to about 45 wt. %, about 15 wt. % to about 40 wt. %, about 15 wt. % to about 35 wt. %, about 15 wt. % to about 30 wt. %, about 15 wt. % to about 25 wt. %; from about 20 wt. % to about 50 wt. %, about 20 wt. % to about 45 wt. %, about 20 wt. % to about 40 wt. %, about 20 wt. % to about 35 wt. %, about 20 wt. % to about 30 wt. %; from about 25 wt. % to about 50 wt. %, about 25 wt. % to about 45 wt. %, about 25 wt. % to about 40 wt. %, about 25 wt. % to about 35 wt. %; from about 30 wt. % to about 50 wt. %, about 30 wt. % to about 45 wt. %, about 30 wt. % to about 40 wt. %, about 30 wt. % to about 35 wt. %; from about 35 wt. % to about 50 wt. %, about 35 wt. % to about 45 wt. %, about 35 wt. % to about 40 wt. %, about 40 wt. % to about 50 wt. %, about 40 wt. % to about 45 wt. %, based on the total weight of the cleaning composition—including all percentages and sub-ranges there-between.

In some embodiments, the solidifying agent may be present in an amount ranging from about 10 wt. % to about 35 wt. %, based on the total weight of the cleaning composition-including all percentages and sub-ranges there-between. In some embodiments, the solidifying agent may be present in an amount ranging from about 15 wt. % to about 30 wt. %, based on the total weight of the cleaning composition—including all percentages and sub-ranges there-between. In some embodiments, the solidifying agent may be present in an amount ranging from about 20 wt. % to about 28 wt. % based on the total weight of the cleaning composition—including all percentages and sub-ranges there-between.

The solidification agent is preferably provided dispersed throughout the cleaning composition to bind the various components together to provide a solid shape (as discussed in greater detail herein). Solidification agents may also be called solidification agents and encompass hardening agents, such as polyethylene glycol (“PEG”). The solidification agents may be selected from polyethylene glycol, a polypropylene glycol, a block polymer of polyethylene glycol polypropylene glycol, polypropylene glycol polyoxyalkylene or a combination of two or more thereof. In some cases, the solidification agent(s) may have molecular weight of from about 100 to 5000 g/mol. For instance, the solidification agent may comprises a polypropylene glycol, a polypropylene glycol, a polypropylene glycol polyoxyalkylene, and/or a block polymer of polyethylene glycol and polypropylene glycol having a molecular weight of about 100 to about 900, about 200 to about 800, about 400, about 1500 to about 2500, about 2000 to about 4500 or any range or subrange thereof. In some embodiments, the solidification agent is a polyethylene glycol and/or a polypropylene glycol polyoxyalkylene having a molecular weight range from 200 to 800. For example, the solidification agent may comprise polyethylene glycol 200, polyethylene glycol 300, polyethylene glycol 400, polyethylene glycol 600, polyethylene glycol 800, or a combination of two or more thereof.

Additional solidification agents include cellulose. Examples of celluloses include carboxymethylcellulose (CMC), ethylcellulose (EC), hydroxypropylcellulose (HPC), hydroxypropylmethylcellulose (HPMC), methylhydroxyethylcellulose (MHEC), and combinations thereof. In some instances, the cellulose may be a modified cellulose selected from microcrystalline cellulose (MCC), e.g., in the anhydrous or hydrated forms thereof, and cellulose ethers such as hydroxypropylcellulose (HPC) and hydroxypropylmethylcellulose (HPMC).

The binding agent may be used as the primary binding agent or as a secondary binding agent of the cleaning composition. The term “primary binding agent” refers to the binding agent that is the primary source for causing the solidification of the cleaning composition. The term “secondary binding agent” refers to the binding agent that acts as an auxiliary binding agent in combination with another primary binding agent. The secondary binding agent can be used to enhance solidification of the cleaning composition and/or help accelerate the solidification of the cleaning composition. Using the binding agent component of the invention as a secondary binding agent component is useful when the primary binding agent component does not solidify the cleaning composition at a desired rate. Accordingly, the secondary binding agent component can be used to help accelerate the solidification process.

In a non-limiting embodiment, the solidification agent may comprise polyethylene glycol (“PEG”). In a non-limiting embodiment, the solidification agent may comprise polypropylene glycol polyoxyalkylene. In some embodiments, the polyethylene glycol may be the primary binder agent and the polypropylene glycol polyoxyalkylene may be the auxiliary binding agent.

In a non-limiting embodiment, the polyethylene glycol may be present in an amount ranging from about 5 wt. % to about 20 wt. %, based on the total weight of the cleaning composition—including all percentages and sub-ranges there-between. In some embodiments, the polyethylene glycol may be present in an amount ranging from about 10 wt. % to about 15 wt. %, based on the total weight of the cleaning composition—including all percentages and sub-ranges there-between.

In a non-limiting embodiment, the polypropylene glycol polyoxyalkylene may be present in an amount ranging from about 5 wt. % to about 25 wt. %, based on the total weight of the cleaning composition—including all percentages and sub-ranges there-between. In some embodiments, the polypropylene glycol polyoxyalkylene may be present in an amount ranging from about 10 wt. % to about 20 wt. %, based on the total weight of the cleaning composition-including all percentages and sub-ranges there-between.

The cleaning composition may further comprise one or more foam controllers, foam boosters, and abrasives. A non-limiting example of abrasives include sodium chloride. The abrasive may be present in an amount ranging from about 0.1 wt. % to about 2.0 wt. % based on the total weight of the cleaning composition—including all percentages and sub-ranges there-between. In some embodiments, the abrasive may be present in an amount ranging from about 0.3 wt. % to about 1.5 wt. %, based on the total weight of the cleaning composition—including all percentages and sub-ranges there-between. In some embodiments, the abrasive may be present in an amount ranging from about 0.4 wt. % to about 1.0 wt. %, based on the total weight of the cleaning composition—including all percentages and sub-ranges there-between.

The cleaning composition may further comprise one or more of a colorant, fragrance/perfumes, and combinations thereof. The colorant may be present in an amount ranging from about 0.1 wt. % to about 1.0 wt. %, based on the total weight of the cleaning composition—including all percentages and sub-ranges there-between. The fragrance/perfume may be present in an amount ranging from about 3.0 wt. % to about 8.0 wt. %, based on the total weight of the cleaning composition—including all percentages and sub-ranges there-between.

Non-limiting examples of colorant include dyes that may alter the appearance of the cleaning composition-such as, but not limited to, Direct Blue 86 (Miles), Fastusol Blue (Mobay Chemical Corp.), Acid Orange 7 (American Cyanamid), Basic Violet 10 (Sandoz), Acid Yellow 23 (GAF), Acid Yellow 17 (Sigma Chemical), Sap Green (Keyston Analine and Chemical), Metanil Yellow (Keystone Analine and Chemical), Acid Blue 9 (Hilton Davis), Sandolan Blue/Acid Blue 182 (Sandoz), Hisol Fast Red (Capitol Color and Chemical), Fluorescein (Capitol Color and Chemical), Acid Green 25 (Ciba-Geigy), Liquitint color (Milliken) and the like.

Non-limiting examples of fragrances or perfumes may include terpenoids such as citronellol, aldehydes such as amyl cinnamaldehyde, a jasmine such as CIS-jasmine or jasmal, vanillin, and the like.

The cleaning composition of the present invention may be manufactured according to the following process. A first step may include blending together the antibacterial composition, the effervescent component, the separate alkaline source, the surfactant composition, and the solidifying agent to form a precursor blend. The precursory blend may further comprise the fragrance/perfume and/or colorant.

The precursor blend may be a 100% solids blend-meaning that the precursory blend is substantially free of all liquid carrier. In other embodiments, the precursor blend may comprise an anhydrous liquid carrier. In a non-limiting embodiment, the anhydrous liquid carrier may be a solvent selected from one or more of ethanol and/or isopropyl alcohol. The precursor blend may then be agitated to ensure that the various components and ingredients are thoroughly and evenly mixed throughout the precursor blend.

Subsequently, the precursor blend may be processed into a solid shape. The processing into a solid shape step may comprise a machining step of compressing the blend into a shape (such as a tablet) and/or granulating the precursor blend into a powder. During the processing into a solid shape step, any liquid carrier that may be present in the precursor blend may be evaporated off such that the resulting solid shape is substantially free of liquid carrier. The solid shape may have a solid content of about 100%.

The cleaning composition of the present invention may be referred to as a solid cleaning composition. The term “solid” may refer to a referenced composition that is substantially free of liquid carrier (e.g., water, ethanol, etc.).

Subsequently, a container may be filled with an amount of the solid shape of the cleaning composition (e.g., either as tablets or powder)—either for temporary storage or transportation.

The present invention further provides for a method of cleaning a surface, the method comprising blending together a volume of water with the cleaning composition. Immediately before the cleaning composition is blended with water, the cleaning composition may be in a solid state. Once combined with water, the cleaning composition may undergo an effervescent dissolution into the water-thereby forming a dissolved liquid cleaning composition.

Subsequently, the dissolved liquid cleaning composition may be applied to the surface of an article. Non-limiting examples of surfaces of articles include counter tops, insides of duffel bags, locker room benches, workout equipment, toilet, etc.

The cleaning composition and water may be blended such that the dissolved cleaning composition has as solids content ranging from about 0.10% to about 15%, by weight of the total dissolved liquid cleaning composition. Stated otherwise, the cleaning composition may have a concentration of about 5% to about 15%, based on the total weight of the dissolved liquid cleaning composition—including all percentages and sub-ranges there-between.

The dissolved liquid cleaning composition may be applied to and contact the surface of an article for a period of time that ranges from about 10 seconds to about 600 seconds—including all times and sub-ranges there-between. In some embodiments, the period of time may range from about 10 seconds to about 300 seconds.

Some embodiments of the present invention provide cleaning compositions wherein the weight ratio of the sodium percarbonate and the tetraacetylethylenediamine is about 2:1. In some embodiments, the antibacterial composition is present in an amount ranging from about 4.5 wt. % to about 18 wt. %, based on the total weight of the cleaning composition.

In some embodiments, the alkali metal bicarbonate comprises sodium bicarbonate. In other embodiments, the alkali metal bicarbonate is present in an amount ranging from about 15 wt. % to about 35 wt. %, based on the total weight of the cleaning composition.

In some embodiments, the alkali metal carbonate comprises sodium carbonate. In certain embodiments, the alkali metal carbonate is present in an amount ranging from about 1 wt. % to about 20 wt. %, based on the total weight of the cleaning composition.

In some embodiments, the acid source comprises citric acid. In further embodiments, the acid source is present in an amount ranging from about 5 wt. % to about 15 wt. %, based on the total weight of the cleaning composition.

In some embodiments, the cleansing compositions further comprise a surfactant composition that is present in an amount ranging from about 1 wt. % to about 45 wt. %, based on the total weight of the cleaning composition. In some embodiments, the surfactant composition comprises one or more of sodium lauryl sulfate, neodol, and combinations thereof. In other embodiments, the surfactant composition comprises sodium lauryl sulfate, the sodium lauryl sulfate being present in an amount ranging from about 15 wt. % to about 28 wt. %, based on the total weight of the cleaning composition. In certain embodiments, the surfactant composition comprises neodol in an amount ranging from about 1 wt. % to about 6 wt. %, based on the total weight of the cleaning composition.

In some embodiments, the cleansing compositions further comprise a solidifying agent in an amount ranging from about 10 wt. % to about 35 wt. %, based on the total weight of the cleaning composition. In other embodiments, the solidifying agent comprises one or more of polypropylene glycol polyoxyalkylene, polyethylene glycol, and combinations thereof. In further embodiments, the solidifying agent comprises polypropylene glycol polyoxyalkylene, the polypropylene glycol polyoxyalkylene being present in an amount ranging from about 10 wt. % to about 20 wt. %, based on the total weight of the cleaning composition. In certain embodiments, the solidifying agent comprises polyethylene glycol in an amount ranging from about 10 wt. % to about 15 wt. %, based on the total weight of the cleaning composition.

In some embodiments, the cleansing compositions comprise an abrasive agent that is present in an amount ranging from about 0.1 wt. % to about 2.0 wt. %, based on the total weight of the cleaning composition. In certain embodiments, the abrasive agent comprises sodium chloride.

In some embodiments, the cleaning composition has a solids content of about 100% based on the total weight of the cleaning composition. In some embodiments, the cleaning composition has a pH ranging from about 8 to about 9. In some embodiments, the cleansing compositions of the present invention further comprise from about 3 wt. % to about 5 wt. %, fragrance.

### EXAMPLES

The following experiments tested the reduction in bacterial presence of the cleaning composition of the present invention. The formulation of each example is set forth below in Table 1.

The base composition comprises a blend of sodium bicarbonate, citric acid, sodium chloride, sodium lauryl sulfate, C9-C11 alcohol EO 7.5-8:1 (also referred to as “neodol”), polypropylene glycol polyoxyalkylene (“PPG”); polyethylene glycol (“PEG”), as well as dye and fragrance.

Additional components in the testing formulation include:
Trichloroisocyanuric acid (“TCCA”)
2-Benzyl-4-Chlorophenol (“OBCP”)

TABLE 1

| | | | | Comp. | Comp. | Comp. | Comp. | Comp. | Comp. | Comp. |
|---|---|---|---|---|---|---|---|---|---|---|
| | Ex. 1 | Ex. 2 | Ex. 3 | Ex. 1 | Ex. 2 | Ex. 3 | Ex. 4 | Ex. 5 | Ex. 6 | Ex. 7 |
| | Wt. % | | | | | | | | | |
| Base Composition | 82 | 95.5 | 95.5 | 99 | 99 | 95 | 97.5 | 97 | 97.5 | 97.5 |
| TCCA | — | — | — | 1 | — | 2.5 | — | — | 2.5 | — |
| OBCB | — | — | — | | 1 | — | 2.5 | 3 | | 2.5 |
| Sodium Percarbonate | 12 | 3 | 3 | — | — | — | — | — | — | — |
| TAED | 6 | 1.5 | 1.5 | — | — | — | — | — | — | — |
| Water-Dissolved | 5.7 | 5.7 | 10.7 | 2.3 | 1.2 | 2.9 | 2.9 | 5.7 | 10.7 | 10.7 |
| Solid's Content | | | | | | | | | | |
| Antibacterial | Pass | Pass | Pass | Fail | Fail | Fail | Fail | Fail | Pass | Fail |
| Test | | | | | | | | | | |

Each solid formulation was dissolved in water to the corresponding solid's content listed in Table 1. The resulting dissolved formulation was then subjected to a bacteria kill test. The bacteria kill test exposure to E. coli, S. typhimurium, S. aureus, and P. aeruginosa bacterium, whereby an initial concentration of each bacterium was measure before contact with the dissolved formulation, followed by contact with each dissolved formulation for a set period of time, removal of each dissolved formulation once the set period of time had expired, and subsequently measuring a final concentration of each bacterium.

Depending on the reduction in bacterium after exposure to the dissolved formulations, each test was assigned a pass or fail grade. The pass grade indicating at least a 5.6 log reduction bacteria (99.999% reduction).

While the invention has been described with respect to specific examples including presently preferred modes of carrying out the invention, those skilled in the art will appreciate that there are numerous variations and permutations of the above described systems and techniques. It is to be understood that other embodiments may be utilized and structural and functional modifications may be made without departing from the scope of the present invention. Thus, the spirit and scope of the invention should be construed broadly as set forth in the appended claims.

1. A cleaning composition comprising:
an alkali metal bicarbonate;
an alkali metal carbonate;
an acid source;
an antibacterial composition tetraacetylethylenediamine; and
comprising sodium percarbonate and
wherein the sodium percarbonate is present in an amount ranging from about 2 wt. % to about 15 wt. % based on the total weight of the cleaning composition, and the tetraacetylethylenediamine in an amount ranging from about 1 wt. % to about 7 wt. % based on the total weight of the cleaning composition.

2. The cleaning composition according to claim 1, wherein the sodium percarbonate is present in an amount ranging from about 2 wt. % to about 4 wt. % and the tetraacetylethylenediamine is present in an amount ranging from about 1 wt. % to about 2 wt. % based on the total weight of the cleaning composition.

3. The cleaning composition according to claim 1, wherein the sodium percarbonate is present in an amount ranging from about 11 wt. % to about 13 wt. % and the tetraacetylethylenediamine is present in an amount ranging from about 5 wt. % to about 7 wt. % based on the total weight of the cleaning composition.

4. The cleaning composition according to claim 1, any foregoing claim 1,
wherein the alkali metal bicarbonate, optionally wherein the alkali metal bicarbonate is present in an amount ranging from about 15 wt. % to about 35 wt. % based on the total weight of the cleaning composition, further optionally wherein the alkali metal bicarbonate comprises sodium bicarbonate.

5. The cleaning composition according to claim 1, wherein the alkali metal carbonate comprises sodium carbonate.

6. The cleaning composition according to claim 5, wherein the alkali metal carbonate is present in an amount ranging from about 1 wt. % to about 20 wt. % based on the total weight of the cleaning composition.

7. The cleaning composition according to claim 1, wherein the acid source comprises citric acid, optionally wherein the acid source is present in an amount ranging from about 5 wt. % to about 15 wt. % based on the total weight of the cleaning composition.

8. The cleaning composition according to claim 1, further comprising a surfactant composition that is present in an amount ranging from about 1 wt. % to about 45 wt. % based on the total weight of the cleaning composition, optionally wherein the surfactant composition comprises one or more of sodium lauryl sulfate, neodol, and combinations thereof.

9. The cleaning composition according to claim 8, wherein the surfactant composition comprises sodium lauryl sulfate, the sodium lauryl sulfate being present in an amount ranging from about 15 wt. % to about 28 wt. % based on the total weight of the cleaning composition.

10. The cleaning composition according to claim 8, wherein the surfactant composition comprises neodol in an amount ranging from about 1 wt. % to about 6 wt. % based on the total weight of the cleaning composition.

11. The cleaning composition according to claim 1, further comprising a solidifying agent in an amount ranging from about 10 wt. % to about 35 wt. % based on the total weight of the cleaning composition, optionally wherein the solidifying agent comprises one or more of polypropylene glycol polyoxyalkylene, polyethylene glycol, and combinations thereof.

12. The cleaning composition according to claim 11, wherein the solidifying agent comprises polypropylene glycol polyoxyalkylene, the polypropylene glycol polyoxyalkylene being present in an amount ranging from about 10 wt. % to about 20 wt. % based on the total weight of the cleaning composition.

13. The cleaning composition according to claim 11, wherein the solidifying agent comprises polyethylene glycol in an amount ranging from about 10 wt. % to about 15 wt. % based on the total weight of the cleaning composition.

14. The cleaning composition according to claim 1, further comprising an abrasive agent that is present in an amount ranging from about 0.1 wt. % to about 2.0 wt. % based on the total weight of the cleaning composition, optionally wherein the abrasive agent comprises sodium chloride.

15. The cleaning composition according to claim 1, wherein the cleaning composition has a solids content of about 100% based on the total weight of the cleaning composition.

16. The cleaning composition according to claim 1, wherein the cleaning composition has a pH ranging from about 8 to about 9.

17. (canceled)

18. A cleaning composition comprising
sodium bicarbonate;
sodium carbonate;
citric acid;
surfactant composition;
sodium percarbonate;
tetraacetylethylenediamine; and
wherein the sodium percarbonate is present in an amount ranging from about 2 wt. % to about 15 wt. % based on the total weight of the cleaning composition, and the tetraacetylethylenediamine in an amount ranging from about 1 wt. % to about 7 wt. % based on the total weight of the cleaning composition so long as the sodium percarbonate and the tetraacetylethylenediamine are present in a weight ratio ranging from about 1:1 to about 3:1.

19. A method of cleaning a surface, the method comprising:
a) blending together a volume of water with the cleaning composition according to claim 1 to create a dissolved liquid cleaning composition; and
b) applying the dissolved liquid cleaning composition to the surface.
